(19) United States
(12) Patent Application Publication
(10) Pub. No.: US 2024/0288027 A1
(43) Pub. Date: Aug. 29, 2024

(54) Fastening Arrangement for Fastening Two Objects to Each Other

(71) Applicant: Robert Bosch GmbH, Stuttgart (DE)

(72) Inventors: Frederic Cousin, Freiberg Am Neckar (DE); Ibrahim Mansour, Heilbronn (DE); Thomas Breinlinger, Isny (DE); Werner Steinberger, Immenstadt (DE)

(21) Appl. No.: 18/573,508

(22) PCT Filed: Jun. 27, 2022
(86) PCT No.: PCT/EP2022/067579

§ 371 Date: Dec. 22, 2023

(30) Foreign Application Priority Data
Jul. 6, 2021 (DE) 10 2021 207 069.8

(51) Int. Cl. F16B 39/282; F16B 5/02

(52) U.S. Cl. CPC F16B 39/282; F16B 5/02

(57) ABSTRACT

A fastening arrangement is for fastening two objects together and includes a plastic flange and a screw. The plastic flange is formed on a first object and bears on a second object. The screw includes a screw head and a threaded shank. The plastic flange defines a through-opening through which the threaded shank of the screw is guided and is screwed into a corresponding threaded bore in the second object, such that an underside of the screw head bears on a bearing region at an edge of the through-opening on the plastic flange. A first corrugation profile is defined on the bearing region of the plastic flange, and a harder, second corrugation profile is defined on the underside of the screw head. In the screwed state, on account of a pretensioning force, the second corrugation profile plastically and elastically deforms the first corrugation profile and brings about a force-fit engagement.

Fastening arrangement for fastening two objects to each other. The subject matter of the present invention is also a sensor arrangement for a vehicle with such a fastening arrangement.

From the prior art, sensors, such as wheel speed sensors, and a variety of other vehicle components are known, which are very often screwed to corresponding carriers in the vehicle. Typically, for components having a plastic flange, a metallic bushing is injected or assembled into the plastic flange. The objective is to represent a pretensioned screw connection that is completely metallic and prevents the screw connection from being loosened under load in the vehicle.

In order to prevent loosening of the screw connection under load, locking screws are also known from the prior art, which have lower head serrations or ribs on the screw head. These dig plastically and/or elastically into a metallic subsurface. For this purpose, the screw head is designed harder than the metallic substrate. Metal locking washers are also known, which can also prevent or at least make it more difficult for the screw connection to loosen under load.

From DE 10 2017 216 533 A1, a sensor unit for a vehicle is known, with a holder comprising two power buses, a measurement transducer and a plug module. An internal electrical interface to the measurement transducer is formed at the first ends of the two power buses. An external electric interface for the connection module is formed at the second ends of the two power buses. In addition, the connector module, the holder, and the alignment component are at least partially surrounded by a plastic overmolding. Furthermore, a fastening module comprising a bushing injected into a plastic tab is formed on the plastic overmolding.

### DISCLOSURE OF THE INVENTION

The fastening arrangement for fastening two objects to each other with the features of independent claim 1 has the advantage that the screw cannot loosen itself under load and a residual pretensioning of the screw connection is retained. In addition, a bushing in the plastic flange known from the prior art can be eliminated.

In order to prevent the screw from loosening itself, the screw below the head has a corrugation profile, which can be inexpensively embossed during screw manufacturing. As a counterpart, the plastic flange also has a matching corrugation profile in the region of the support region, which can be produced in the injection molding tool in a cost-neutral manner. Together with the screw, force-fit engagement that secures against loosening is thus formed. Due to the design of the corrugation profiles on the screw head and on the plastic flange, further components, such as a lock washer, are advantageously not required in order to prevent the screw from loosening itself under load.

Embodiments of the present invention provide a fastening arrangement for fastening two objects to each other, with a plastic flange formed on a first object, which bears on a second object, and a screw comprising a screw head and a threaded shank. The plastic flange comprises a through-opening through which the threaded shank of the screw is guided and so screwed into a corresponding threaded bore in the second object, such that an underside of the screw head bears on a bearing region at the edge of the through-opening on the plastic flange. In this case, a first corrugation profile is introduced at the bearing region of the plastic flange and a harder, second corrugation profile is introduced at the underside of the screw head, which, in the screwed state, plastically and elastically deforms the first corrugation profile and brings about a force-fit engagement that secures against loosening.

In addition, a sensor arrangement for a vehicle, with a sensor as the first object and a carrier as the second object, is proposed. Here, the sensor and the carrier are attached to each other via such a fastening arrangement.

Of course, embodiments of the fastening arrangement according to the invention may also be used outside of a vehicle to fasten two objects to each other.

In the present case, a sensor is understood to be a component unit comprising at least one sensor element, which is arranged in a housing. The housing of the sensor may be fastened to another object, for example a carrier, via a fastening module comprising the plastic flange. The at least one sensor element is arranged to sense a physical variable or a change of a physical quantity directly or indirectly and preferably to convert it into an electrical sensor signal. This can take place, for example, by emitting and/or receiving sound waves and/or electromagnetic waves, and/or via a magnetic field or the change in a magnetic field and/or the reception of satellite signals, for example a GPS signal. Also possible are optical sensor elements, having a photo plate and/or a fluorescent surface and/or a semiconductor, for example, which detect the impact or intensity, wavelength, frequency, angle, etc. of the received wave, for example infrared sensor elements. Likewise, an acoustic sensor element is conceivable, for example an ultrasonic sensor element and/or a high frequency sensor element and/or a radar sensor element and/or a sensor element which reacts to a magnetic field, for example a Hall sensor element and/or a magnetoresistive sensor element and/or an inductive sensor element that registers the change of a magnetic field, for example via the voltage generated by magnetic induction.

Advantageous improvements of the fastening arrangement for fastening two objects to each other specified in independent claim 1 and the sensor arrangement specified in independent claim 9 are enabled by the measures and developments listed in the dependent claims.

It is particularly advantageous that a first slope of the first corrugation profile and a second slope of the second corrugation profile may each be larger than a thread pitch of the threaded shank of the screw. The different slopes of the corrugation profiles and the threaded shank bring about the pretensioning force in the screwed state. This effectively prevents or at least impedes the screw connection unscrewing or loosening itself under load.

In an advantageous configuration of the fastening arrangement, the first slope of the first corrugation profile can be smaller than the second slope of the second corrugation profile. In addition, a height of the second corrugation profile may be greater than a height of the first corrugation profile. This may simplify screwing the screw.

In another advantageous embodiment of the fastening arrangement, the plastic flange may be manufactured as an injection molded part from a fiber-reinforced plastic. The fiber-reinforced plastic is more resilient along its fiber direction than perpendicular to the fiber direction. In addition, the elongational behavior of the fiber-reinforced plastic along the fiber direction is less temperature-dependent than perpendicular to the fiber direction. Furthermore, the fiber-reinforced plastic creeps and relaxes more slowly when loaded or unloaded along the fiber direction than perpendicular to the fiber direction. Therefore, a fiber direction of reinforcing fibers of the fiber-reinforced plastic in the bearing region of the plastic flange may extend radially to the through-opening to increase the reliability of securing against loosening. Thus, the reinforcing fibers of the fiber-reinforced plastic may be aligned along troughs and crests of the first corrugation profile so that when the screw is loosened, a compressive load in the region of the troughs and a tensile load in the region of the crests runs along the reinforcing fibers. This significantly increases the reliability of securing against loosening, as the load is greatest when loosening along the fiber direction. Such an alignment of the reinforcing fibers may be caused, for example, by a suitable selection of an injection point during the injection molding process.

In another advantageous embodiment of the fastening arrangement, the plastic flange in the bearing region can have a thickness in the range of 2 mm to 5 mm. This can further improve the creepage and/or settling behavior of the plastic flange and thus the reliability of securing against loosening.

In an advantageous configuration of the sensor arrangement, the plastic flange can be configured as part of a fastening module of the sensor. For example, the fastening module with the plastic flange may be molded to a housing of the sensor or connected to the housing of the sensor.

Exemplary embodiments of the invention are illustrated in the drawings and explained in greater detail in the subsequent description. In the drawings, identical reference numbers refer to components or elements performing identical or similar functions.

### BRIEF DESCRIPTION OF THE DRAWINGS

FIG. 1 shows a schematic perspective sectional view of an exemplary embodiment of a sensor arrangement according to the invention with an exemplary embodiment of a fastening arrangement according to the invention.

FIG. 2 shows a schematic perspective view of a screw of the fastening arrangement according to the invention of FIG. 1.

FIG. 3 shows a schematic perspective view of the screw of the fastening arrangement according to the invention from FIG. 1 inserted into a through-opening of the plastic flange.

FIG. 4 shows a schematic perspective view of a fastening module of a sensor with a plastic flange of the fastening arrangement according to the invention of FIG. 1.

### EMBODIMENTS OF THE INVENTION

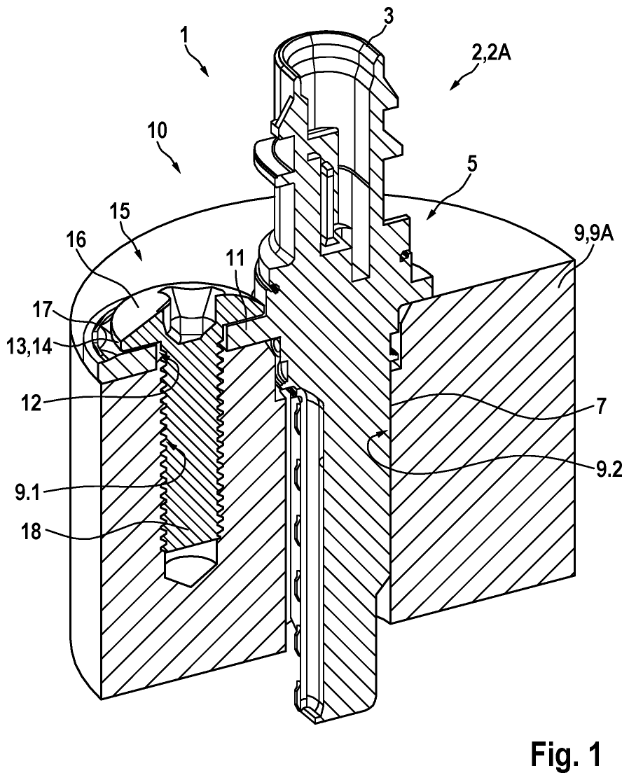

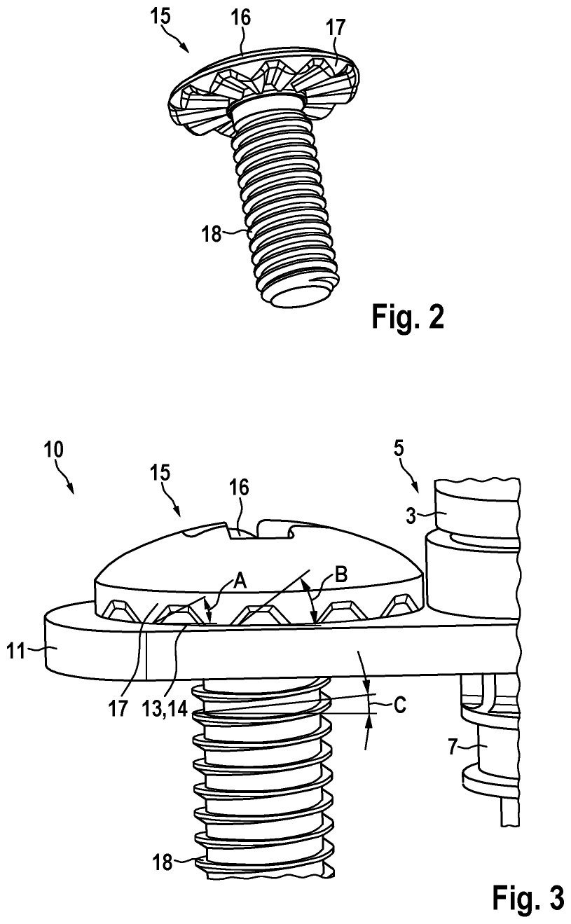

As can be seen from FIGS. 1 to 4, the illustrated exemplary embodiment of a fastening arrangement 10 according to the invention for fastening two objects 2, 9 to each other comprises a plastic flange 11, which is formed on a first object 2 and bears on a second object 9, and a screw 15, which comprises a screw head 16 and a threaded shank 18. The plastic flange 11 comprises a through-opening 12 through which the threaded shank 18 of the screw 15 is guided and so screwed into a corresponding threaded bore 9.1 in the second object 9, such that an underside of the screw head 16 bears on a bearing region 13 at the edge of the through-opening 12 on the plastic flange 11. In this case, a first corrugation profile 14 is introduced at the bearing region 13 of the plastic flange 11, and a harder, second corrugation profile 17 is introduced on the underside of the screw head 16, which, in the screwed state, on account of a pretensioning force, plastically and elastically deforms the first corrugation profile 14 and brings about force force-fit engagement that secures against loosening.

As can be further seen from FIG. 3, a first slope A of the first corrugation profile 14 and a second slope B of the second corrugation profile 17 are each larger than a thread pitch C of the threaded shank 18 of the screw 15. In addition, in the illustrated exemplary embodiment, the first slope A of the first corrugation profile 14 is smaller than the second slope B of the second corrugation profile 17. Furthermore, a height of the second corrugation profile 17 is greater than a height of the first corrugation profile 14.

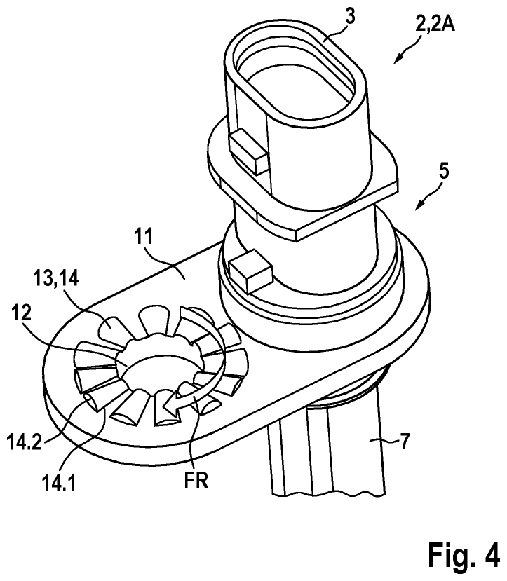

In the illustrated design example of the fastening arrangement 10, the plastic flange 11 is manufactured as an injection-molded part from a fiber-reinforced plastic and has a thickness in the bearing region 13 in the range of 2 mm to 5 mm. As can further be seen from FIG. 4, a fiber direction FR of reinforcing fibers of the fiber-reinforced plastic in the bearing region 13 of the plastic flange 11 extends radially to the through-opening 12. As a result, the reinforcing fibers of the fiber-reinforced plastic are aligned along troughs 14.1 and crests 14.2 of the first corrugation profile 14, such that when the screw 15 is loosened, a compressive load in the area of the troughs 14.1 and a tensile load in the area of the crests 14.2 runs along the reinforcing fibers.

As can further be seen from FIG. 1, the fastening arrangement 10 in the illustrated exemplary embodiment is used in a sensor arrangement 1 for a vehicle 1 to fasten a sensor 2A as the first object 2 and a carrier 9A as the second object 9 to each other. As can further be seen from FIG. 1, a housing 7 of the sensor 2A is inserted into a sensor receiver 9.2 of the carrier 9A, which is designed as a stepped bore, so that the plastic flange 11 bears on the carrier 9A.

As can be seen further from FIG. 1, the plastic flange 11 in the illustrated exemplary embodiment is configured as part of a fastening module 5 of the sensor 2A. The fastening module 5 with the plastic flange 11 is connected to the housing 7 of the sensor 2A below a plug receiving area 3, which forms an external electrical interface of the sensor 2A. For this purpose, the fastening module 5 comprises an unspecified ring region, which encompasses the housing 7 of the sensor. In an alternative embodiment of the sensor arrangement 1, which is not shown, the fastening module 5 with the plastic flange 11 is molded onto the housing 7 of the sensor 2A below the plug receiving area 3.

1. A fastening arrangement for fastening two objects to each other, comprising:
a plastic flange formed on a first object and configured to bear on a second object; and
a screw comprising a screw head and a threaded shank,
wherein the plastic flange comprises a through-opening, through which the threaded shank of the screw is guided and is screwed into a corresponding threaded bore in the second object, such that an underside of the screw head bears on a bearing region at an edge of the through-opening on the plastic flange,
wherein a first corrugation profile is defined on the bearing region of the plastic flange,
wherein a harder, second corrugation profile is defined at the underside of the screw head, and
wherein in a screwed state of the screw in the threaded bore, on account of a pretensioning force, the second corrugation profile plastically and elastically deforms the first corrugation profile and brings about a force-fit engagement that secures the screw against loosening.

2. The fastening arrangement according to claim 1, wherein a first slope of the first corrugation profile and a second slope of the second corrugation profile are each larger than a threaded slope of the threaded shank of the screw.

3. The fastening arrangement according to claim 2, wherein the first slope of the first corrugation profile is smaller than the second slope of the second corrugation profile.

4. The fastening arrangement according to claim 1, wherein a height of the second corrugation profile is greater than a height of the first corrugation profile.

5. The fastening arrangement according to claim 1, wherein the plastic flange is an injection-molded part formed from a fiber-reinforced plastic.

6. The fastening arrangement according to claim 5, wherein a fiber direction of reinforcing fibers of the fiber-reinforced plastic in the bearing region of the plastic flange extends radially to the through-opening.

7. The fastening arrangement according to claim 6, wherein the reinforcing fibers of the fiber-reinforced plastic are aligned along troughs and crests of the first corrugation profile, such that, when the screw is loosened, a compressive load in an area of the troughs and a tensile load in an area of the crests runs along the reinforcing fibers.

8. The fastening arrangement according to claim 1, wherein the plastic flange in the bearing region has a thickness from 2 mm to 5 mm.

9. A sensor arrangement for a vehicle comprising:
a sensor as a first object;
a carrier as a second object; and
a fastening arrangement configured to fasten the sensor and the carrier to each other,
wherein the fastening arrangement includes (i) a plastic flange formed on the first object and configured to bear on the second object, and (ii) a screw comprising a screw head and a threaded shank,
wherein the plastic flange comprises a through-opening, through which the threaded shank of the screw is guided and is screwed into a corresponding threaded bore in the second object, such that an underside of the screw head bears on a bearing region at an edge of the through-opening on the plastic flange,
wherein a first corrugation profile is defined on the bearing region of the plastic flange,
wherein a harder, second corrugation profile is defined at the underside of the screw head, and
wherein in a screwed state of the screw in the threaded bore, on account of a pretensioning force, the second corrugation profile plastically and elastically deforms the first corrugation profile and brings about a force-fit engagement that secures the screw against loosening and fastens the sensor to the carrier.

10. The sensor arrangement according to claim 9, wherein the plastic flange is configured as part of a fastening module of the sensor.

11. The sensor arrangement according to claim 10, wherein the fastening module with the plastic flange is molded to a housing of the sensor or connected to the housing of the sensor.
